(19) United States
(12) Patent Application Publication
(10) Pub. No.: US 2004/0044722 A1
(43) Pub. Date: Mar. 4, 2004

(54) Implicit service payments

(76) Inventor: Yevgeniy Epshteyn, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/228,741

(22) Filed: Aug. 27, 2002

(51) Int. Cl. G06F 15/16

(52) U.S. Cl. 709/203

(57) ABSTRACT

Apparatus and methods are provided to allow implicit service payments in client-server environments. According to one embodiment, the present invention includes receiving a request from a client for a connection to a server, sending, to the client, information regarding a computational task to be performed by the client; receiving a result of the computational task, the result representing an implicit payment for access to a resource associated with the server, and allowing the connection between the client and the server to be established.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field

Embodiments of the present invention relate generally to the field of client-server computing and the access of online resources. More particularly, embodiments of the present invention relate to a new business model that involves receiving implicit payments from clients in exchange for access to online resources.

2. Description of the Related Art

Many free resources, such as email service, streaming media service, and multimedia content, have traditionally been available to Internet users. However, in an attempt to decrease reliance on advertising revenues, the current trend appears to be toward offering access to such resources on subscription-based or pay-per-use-based models. Recently, Yahoo! Began surveying its users to get input regarding whether people would pay for particular audio and video programming from its web site. Additionally, members of Microsoft's popular free email service are now being urged to upgrade to a premium version that requires payment of a yearly subscription.

Current subscription-based and pay-per-use-based models have many disadvantages. For example, such resource access models typically require users to register with the web site providing the resource. During the registration process, users are typically required to submit payment information, such as a credit card number to be charged on a monthly or per usage basis. Some users are understandably reluctant to provide payment information if their intention is to use only the free portions of a particular web site. Other users may be reluctant to provide sensitive information, such as credit card numbers, over the Internet or some other network. Yet other users may not wish to spend monetary resources to access content or services. Additionally, for registration models, each time registered users visit the resource provider's web site, they must provide both account identification information and authentication information.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a flow diagram illustrating connection establishment processing by a server according to one embodiment of the present invention.

FIG. 2A is a message exchange diagram illustrating connection establishment according to one embodiment of the present invention.

FIG. 2B is a message exchange diagram illustrating connection establishment according to another embodiment of the present invention.

FIG. 2C is a message exchange diagram illustrating connection establishment according to yet another embodiment of the present invention.

FIG. 3 is a flow diagram illustrating connection establishment processing by a client according to one embodiment of the present invention.

FIG. 4 is a block diagram illustrating an exemplary network environment in which various embodiments of the present invention may be employed.

FIG. 5 is an example of a computer system upon which one embodiment of the present invention may be implemented.

### DETAILED DESCRIPTION

Connection Establishment

Apparatus and methods are described to allow implicit service payments in client-server environments thereby facilitating the creation of viable alternative peer-to-peer (P2P), business-to-business (B2B), and business-to-consumer (B2C) business models. Embodiments of the present invention seek to solve or at least alleviate some problems of conventional client-server business model discussed above by employing a novel mechanism to automatically charge payments for access to a valuable resource, such as premium content, online services, memory resources, or computational resources.

According to one embodiment of the present invention, when a client makes a connection request to a server, the server requires the client to perform useful work on behalf of the server before granting the connection request. The useful work may be a computational task, such as a portion of a distributed computing problem. According other embodiments of the present invention, clients may be granted connections before supplying the useful work to the server or clients may redeem credits for useful work performed in the past.

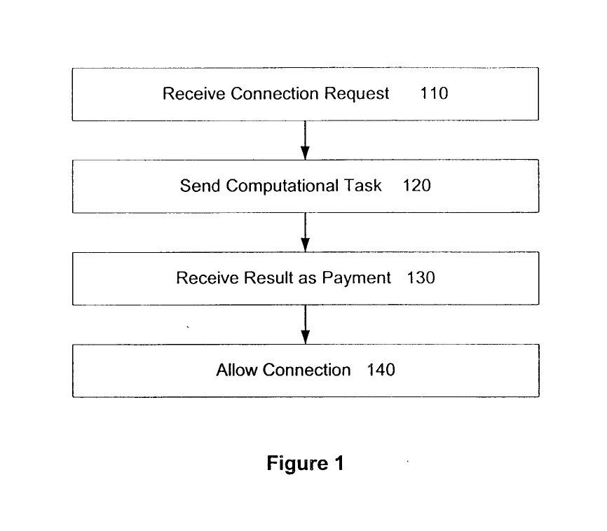

One embodiment of the present invention is now explained with reference to FIG. 1. FIG. 1 is a flow diagram of establishing a connection between a client and a server according to one embodiment of the invention. First, the server receives 110 a request for a connection from the client. The client may want this connection because the server has some resource that the client wishes to access. For example, the server may store some premium content, such as an encyclopedia, stock quotes, or any other content the client wishes to access. The server may provide a network-based service, such as electronic mail (e-mail) or access to another network or another server having some desired resource.

In response to the connection request, the server sends 120 a computational task to the client. The computational task may be sent according to some protocol as a list of instruction and a list of operands, i.e., data to be processed. Alternatively the operation to be performed may be implicit. For example, the computational task may be in the form of (ADD x, y, z). It may also be in the form of (x, y, z) where the client implicitly knows the operation to perform is addition, for example. There are many other ways of sending information about the computational task to be performed.

In one embodiment, the computational task is part of a distributed computing problem. Distributed computing, also known as peer-to-peer (P2P) computing and grid computing, generally involves using the computing resources of multiple machines as one computer. An example of a distributed computing problem is the SETI@home project, which uses the spare clock cycles of many volunteer client computers to process data collected by satellite dishes searching for extra-terrestrial life. Distributed programming can also be used to solve commercial problems, such as gene and protein research for example.

The client solves the computational task and returns the result to be received 130 by the server as an implicit payment for access to the resource the client wants. The server may want the result of the computational task for various reasons. For example, the server operator may have a business plan under which it receives compensation for performing large computational tasks. The server may not have the computational power to perform such a large computational task. Thus, the server may enlist all client computers requesting access to a premium resource to solve the large computational task on a distributed basis by having each client solve a small part of the distributed computing problem as payment for access to the premium resource.

When the payment is received in the form of the result of the computational task sent to the client, the server allows 140 the connection to be established between the server and the client. Thus the client can have access to the resource it wants. The connection may be established using any known connection protocol, such as a TCP/IP based connection protocol, or any other connection protocol not yet developed.

Message Exchange Protocols

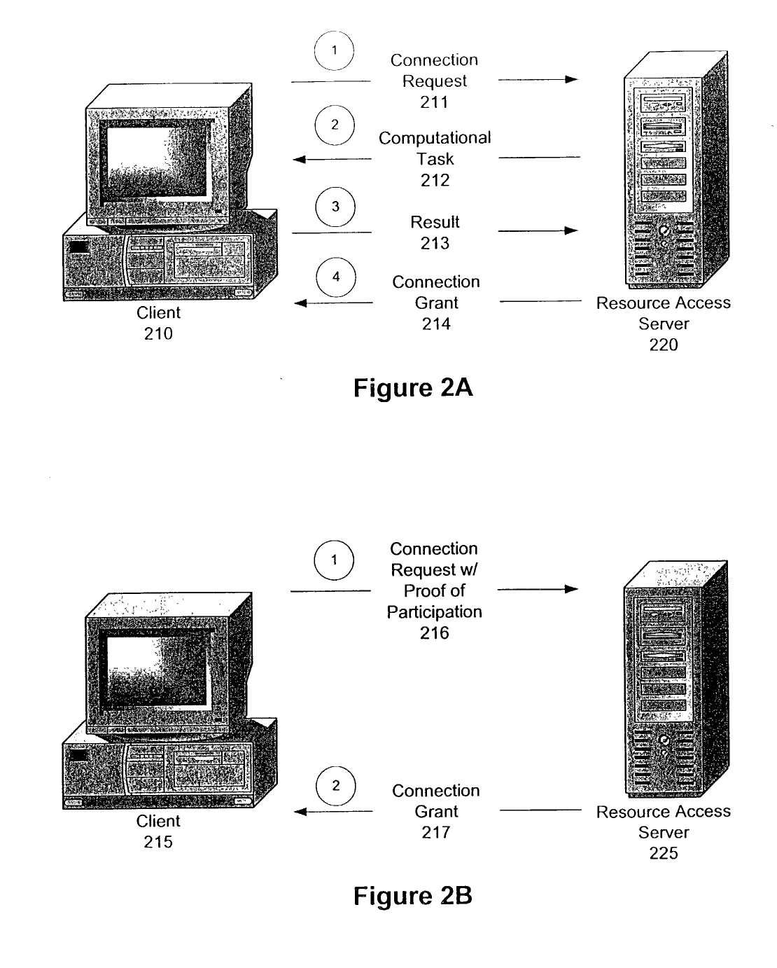

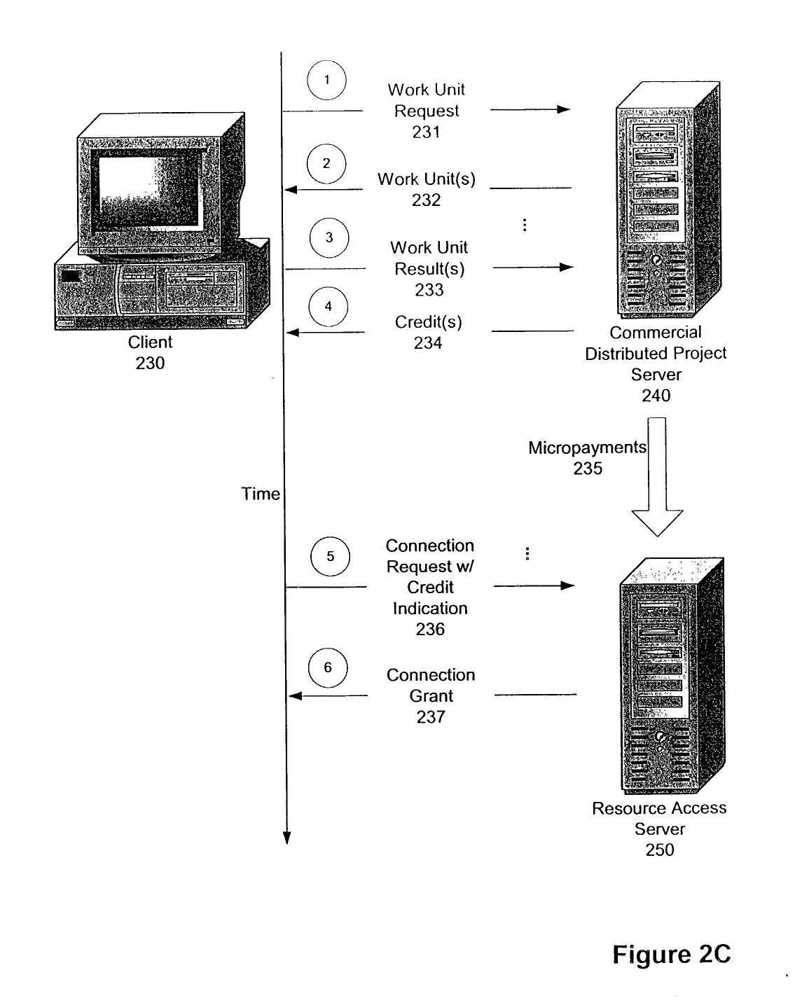

Some message exchange protocols are now described with reference to FIGS. 2A-2C. Many other message exchange protocols can be designed to implement embodiments of the present invention. In FIG. 2A, the process described with reference to FIG. 1 is implemented in the same chronological order. The client 210 send a connection request 211 to a server such as a resource access server 220, which causes the resource access server 220 to send a computational task 212. Again, the computational task may be a part of a distributed computing problem. The client 210 performs the computational task and sends the result 213 back to the resource access server 220 as the implicit payment for the connection 214 granted by the resource access server 220. In this embodiment, the computational task is performed in real time, that is, between the connection request and the connection grant. In such a real time embodiment, it may be desirable that the computational task be small or simple enough that the client can perform it without undue delay. Acceptable delays and computational difficulty depend on the systems and devices used to implement the particular embodiment of the invention and on user expectations.

The example protocol described with reference to FIG. 2A can be implemented as additions to a protocol stack, such as the TCP protocol stack. The TCP protocol stack for connection establishment includes the Client sending a SYN message to the Server, the Server responding with a SYN-ACK message, to which the Client responds with an ACK message, establishing the connection. The TCP protocol stack may be augmented to implement the message exchange protocol described with reference to FIG. 2A by adding a Server-to-Client computational task message to send the computational task, and a Client-to-Server result message to send the result of the computational task between the SYN and the SYN-ACK message exchange.

There are other ways of modifying protocol stacks to implement embodiments of the present invention. Furthermore, the example protocol described with reference to FIG. 2A can also be implemented as a plug-in to network client software, such as a web-browser. Other implementations may be provided as special client or server software. This, and other embodiments of the present invention, such as the embodiments described with reference to FIGS. 2B and 2C below, can also be implemented using any one of the techniques discussed above, or any other suitable technique.

Furthermore, other protocols for collecting implicit payments for allowing a connection are also possible. One such protocol is now described with reference to FIG. 2B. In FIG. 2B, when the client 215 wants to connect to the resource access server 225, the client send a connection request and includes proof of participation 216 with the request. The proof of participation, which may be a code or some other means of authentication, indicates that the client participates in a program under which the resource access server 225 can use the client's 215 computational resources to perform computational tasks.

For example, the client 215 may have installed a screensaver application that allows the resource access server 225 to send computational tasks to the client 215 when the client 215 is not being used. The results of these computational tasks can be sent to the resource access server 225 as implicit payments for future or past connections to the server. Thus, upon receiving the proof of participation 216, the resource access server can grant the connection 217 immediately in return for past or future performance of computational tasks by the participant client.

Another such protocol is described with reference to FIG. 2C. In the embodiment described with reference to FIG. 2C the client 230 earns credits by performing computational tasks, called work units in FIG. 2C, for a Commercial Distributed Project Server 240 that is tasked with coordinating and solving a distributed computing project. These credits are later redeemable for connections to a Resource Access Server 250 having the resource the client 230 wishes to access. The operator of the Resource Access Server may receive micropayments 235 for each connection granted in return for a credit from the operator of the Commercial Distributed Project Server.

According to one embodiment for implementing such a protocol, the client 230 can send a request 231 for a work unit, i.e. part of a distributed computing problem, to the Commercial Distributed Project Server 240 at any time. In response to the request, the Commercial Distributed Project Server 240 sends one or more work units 232 to the client 230. The client 230 performs the computational tasks represented by the one or more work units and returns the results 233 to the Commercial Distributed Project Server 240. The Commercial Distributed Project Server 240 then awards a certain number of credits 234 to the client 230. The number of credits may depend on the number and complexity or size of the work unit or units performed.

At some later time, when the client 230 wants to establish a connection to the Resource Access Server 250, the client sends a connection request including a credit indication 236. For example, each connection may cost the client 230 one credit. Credits may be in the form of codes, such as a string of numbers, or in any other form. The Resource Access Server 250 can verify the authenticity of the credit and grant a connection 237 in response. In such an embodiment, the Commercial Distributed Project Server 240 and the Resource Access Server 250 coordinate to determine which credits are valid and which have already been spent. Various ways of maintaining a credit database on either server can be used to track and award and redeem credits.

There are many other possible message exchange protocols. The three protocols described above are set forth to demonstrate the numerous ways embodiments of the present invention can be practiced. Furthermore, all these embodiments can be implemented in various ways. Some ways to implement these embodiments are additions to connection protocol stacks, plug-ins to client and server software, or specialized client and server software. Other implementations are also possible.

Client-End Connection Establishment

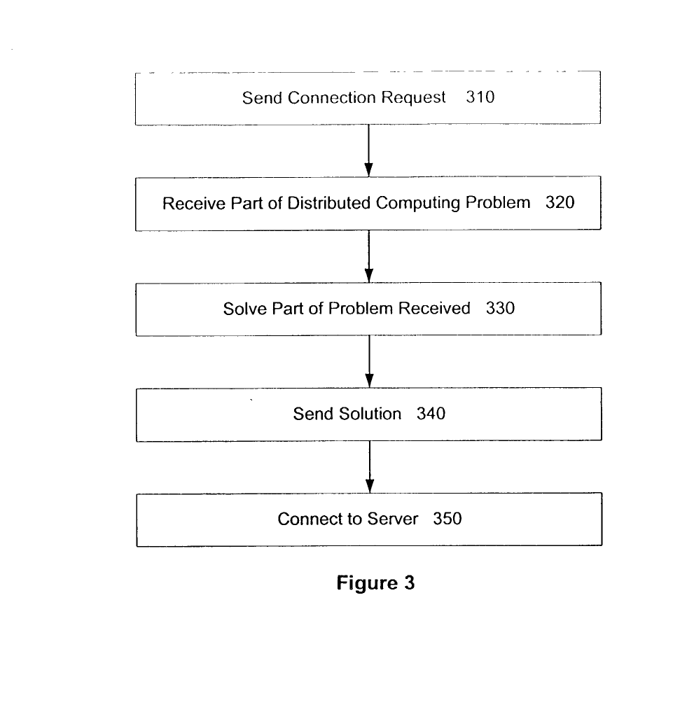

Embodiments of the present invention have been explained in portions of the description above as a process performed by a server. A process performed by a client in implementing an embodiment of the present invention is now described with reference to FIG. 3. In one embodiment, when the client wants to connect to some server to access some desired resource the client sends 310 a connection request to the server. Then, the client receives 320 the part of a distributed computing problem it must solve to be granted access to the server. The client solves 330 the part of the distributed problem it received and sends 340 the solution back to the server. When the sever grants the access, the client connects 350 to the server using some connection protocol.

Example Network Environment

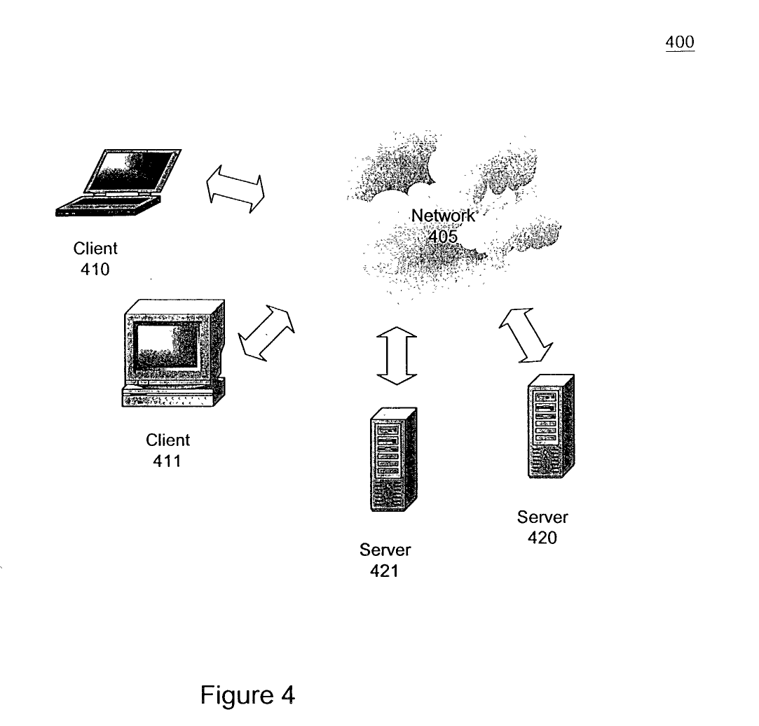

An example network environment in which embodiments of the present invention can be implemented is now described with reference to FIG. 4. FIG. 4 shows clients 410 and 411 and servers 420 and 421 connected to a network 405. There may be many more clients and servers connected to the network 405. The network 405 may be the Internet, an Intranet, or any other network. Clients 410 and 411 are depicted as personal computers (PCs), but they may be workstations, personal digital assistants (PDAs), fax machines, various wireless devices, or other machines capable of communication and computing.

The servers 420 and 421 can be UNIX, LINUX, or Windows servers, or servers using any other networking technology or system software. The servers may also be PCs or any other device that a client may be. In some networks, the designation of server depends on the function currently performed by a machine, not the type of the machine. Thus, it is possible that a machine can sometimes be a server and at other times be a client. Furthermore, embodiments of the present invention may be practiced in networks that do not use the designation of client and server, such as a Peer-to-Peer P2P network.

Example Computer System

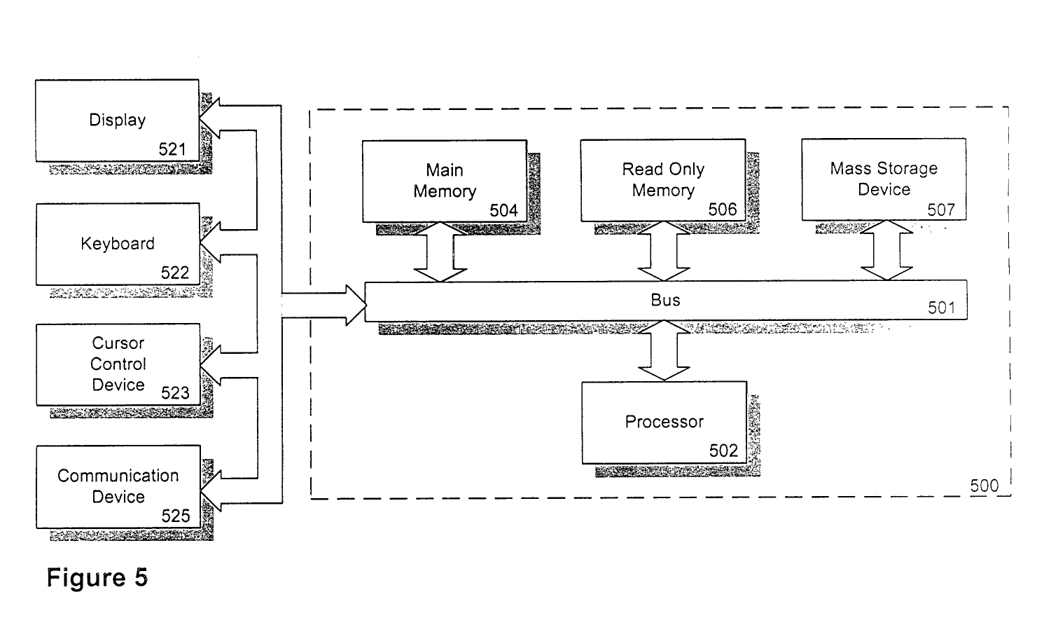

An exemplary machine in the form of a computer system 500 representing an exemplary workstation, client, or server in which features of the present invention may be implemented will now be described with reference to FIG. 5. Computer system 500 comprises a bus or other communication means 501 for communicating information, and a processing means such as one or more processors 502 coupled with bus 501 for processing information. Computer 500 further comprises a random access memory (RAM) or other dynamic storage device 504 (referred to as main memory), coupled to bus 501 for storing information and instructions to be executed by the one or more processors 502. Main memory 504 also may be used for storing temporary variables or other intermediate information during execution of instructions by the one or more processors 502. Computer system 500 also comprises a read only memory (ROM) and/or other static storage device 506 coupled to bus 501 for storing static information and instructions for the one or more processors 502.

A data storage device 507, also referred to as a mass storage device, such as a magnetic disk or optical disc and its corresponding drive may also be coupled to computer system 500 for storing information and instructions. Collectively, the main memory 504, the ROM 506 and the mass storage device 507 can be called machine-readable media internal to the example computer system 500. Computer system 500 can also be coupled via bus 501 to a display device 521, such as a cathode ray tube (CRT) or Liquid Crystal Display (LCD), for displaying information to an end user. Typically, an alphanumeric input device 522, including alphanumeric and other keys, may be coupled to bus 501 for communicating information and/or command selections to the one or more processors 502. Another type of user input device is cursor control 523, such as a mouse, a trackball, or cursor direction keys for communicating direction information and command selections to the one or more processors 502 and for controlling cursor movement on display 521.

A communication device 525 is also coupled to bus 501. Depending upon the particular network environment, the communication device 525 may include a modem, a network interface card, or other well-known interface devices, such as those used for coupling to Ethernet, token ring, or other types of physical attachment for purposes of providing a communication link to support a local or wide area network, for example. In any event, in this manner, the computer system 500 may be coupled to a number of clients and/or servers via a conventional network infrastructure, such as a company's Intranet and/or the Internet, for example.

General Matters

In the description above, for the purposes of explanation, numerous specific details have been set forth. However, it is understood that embodiments of the invention may be practiced without these specific details. In other instances, well-known circuits, structures and techniques have not been shown in detail in order not to obscure the understanding of this description.

Embodiments of the present invention include various processes. The processes may be performed by hardware components or may be embodied in machine-executable instructions, which may be used to cause one or more processors programmed with the instructions to perform the processes. Alternatively, the processes may be performed by a combination of hardware and software.

Embodiments of the present invention may be provided as a computer program product that may include a machine-readable medium having stored thereon instructions, which may be used to program a computer (or other electronic device) to perform a process according to one or more embodiments of the present invention. The machine-readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

For convenience, some embodiments of the present invention have been described with reference to the Transmission Control Protocol/Internet Protocol (TCP/IP) suite of protocols. However, embodiments of the present invention are not limited to any particular network protocol. In addition, while embodiments of the present invention are described with reference to a client providing useful work to a server in exchange for access to a valuable resource, embodiments of the present invention are equally applicable to other types value being provided by the client as well, such as memory, data, or computational resources.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a request from a client for a connection to a server;
sending, to the client, information regarding a computational task to be performed by the client;
receiving a result of the computational task, the result representing an implicit payment for access to a resource associated with the server; and
allowing the connection between the client and the server to be established.

2. The method of claim 1, wherein allowing the connection between the client and the server to be established occurs after receiving the result of the computational task.

3. The method of claim 1, wherein allowing the connection between the client and the server to be established occurs prior to receiving the result of the computational task.

4. The method of claim 1, wherein sending information regarding the computational task and receiving the result of the computational task occurs prior to receiving the request for a connection to the server and allowing the connection to be established.

5. The method of claim 1, wherein receiving the request for a connection, sending information regarding the computational task, receiving the result of the computational task, and allowing the connection between the client and the server to be established is performed by the server.

6. The method of claim 1, wherein sending information regarding the computational task and receiving the result of the computational task is performed by a distributed project server and receiving a request for a connection to the server and allowing the connection to be established is performed by the server.

7. The method of claim 1, wherein the computational task comprises a portion of a distributed computing problem.

8. The method of claim 1, wherein the resource comprises premium content.

9. The method of claim 1, wherein the resource comprises a network-based service.

10. The method of claim 2, wherein the information regarding the computational task is communicated to the client from the server in a protocol message acknowledging the request for the connection.

11. The method of claim 10, wherein the computational task comprises a portion of a distributed computing problem.

12. The method of claim 11, wherein the connection comprises a Transmission Control Protocol (TCP) connection.

13. A method comprising:
sending a request from a client for a connection to a server;
receiving information regarding a computational task to be performed by the client;
calculating a result by performing the computational task;
sending the result to the server, the result representing an implicit payment for access to a resource associated with the server; and
connecting to the server.

14. The method of claim 13, wherein connecting to the server occurs after sending the result of the computational task.

15. The method of claim 13, wherein connecting to the server occurs prior to sending the result of the computational task.

16. The method of claim 13, wherein receiving information regarding the computational task occurs prior to sending the request for a connection to the server and connecting to the server.

17. The method of claim 13, wherein sending a request, receiving information regarding a computational task, calculating a result by performing the computational task, sending the result, and connecting to the server is performed by the client.

18. The method of claim 13, wherein the computational task comprises a portion of a distributed computing problem.

19. The method of claim 13, wherein the resource comprises premium content.

20. The method of claim 13, wherein the resource comprises a network-based service.

21. A server comprising:
a processor;
a communication device coupled to the processor; and
a machine-readable medium coupled to the processor and having stored thereon a protocol which, when executed by the processor, causes the processor to:
receive, through the communication device, a first message from a client coupled to a network, the first message including a request for a connection to the server, the server being coupled to the network using the communication device;
send a second message through the communication device to the client over the network, the second message including information regarding a computational task to be performed by the client;
receive, through the communication device, a third message from the client, the third message including a result of the computational task, the result representing an implicit payment for access to a resource associated with the server; and
allow the client to connect to the server over the network using the communication device.

22. The server of claim 21, wherein the processor allows the connection between the client and the server to be established after receiving the third message including the result of the computational task.

23. The server of claim 21, wherein the processor allows the connection between the client and the server to be established prior to receiving the third message including the result of the computational task.

24. The server of claim 21, wherein the processor sends the second message including information regarding the computational task and receives the third message including the result of the computational task prior to receiving the first message including the request for a connection to the server and prior to allowing the client to connect to the server.

25. The server of claim 21, wherein the computational task comprises a portion of a distributed computing problem.

26. A machine-readable medium having stored thereon data representing instructions which, when executed by a processor of a client, cause the processor to perform operations comprising:
sending a request from the client for a connection to a server;
receiving information regarding a computational task to be performed by the client;
calculating a result by performing the computational task;
sending the result to the server, the result representing an implicit payment for access to a resource associated with the server; and
connecting to the server.

27. The machine-readable medium of claim 26, wherein connecting to the server occurs after sending the result of the computational task.

28. The machine-readable medium of claim 26, wherein connecting to the server occurs prior to sending the result of the computational task.

29. The machine-readable medium of claim 26, wherein receiving information regarding the computational task occurs prior to sending the request for a connection to the server and connecting to the server.

30. The machine-readable medium of claim 26, wherein the computational task comprises a portion of a distributed computing problem.

31. A machine-readable medium having stored thereon data representing instructions which, when executed by a processor of a server, cause the processor to perform operations comprising:
receiving a request from a client for a connection to the server;
sending, to the client, information regarding a computational task to be performed by the client;
receiving a result of the computational task, the result representing an implicit payment for access to a resource associated with the server; and
allowing the connection between the client and the server to be established.

32. The machine-readable medium of claim 31, wherein the allowing the connection between the client and the server to be established occurs after receiving the result of the computational task.

33. The machine-readable medium of claim 31, wherein allowing the connection between the client and the server to be established occurs prior to receiving the result of the computational task.

34. The machine-readable medium of claim 31, wherein sending information regarding the computational task and receiving the result of the computational task occurs prior to receiving the request for a connection to the server and allowing the connection to be established.

35. The machine-readable medium of claim 31, wherein the computational task comprises a portion of a distributed computing problem.
